(19) United States
(12) Patent Application Publication
(10) Pub. No.: US 2023/0316165 A1
(43) Pub. Date: Oct. 5, 2023

(54) OBJECT PACKINGS

(71) Applicants: Hewlett-Packard Development Company, L.P., Spring, TX (US); Instituto Atlântico, Edson Queiroz, Fortaleza (BR)

(72) Inventors: Juan Carlos CATANA SALAZAR, San Diego, CA (US); Alyne GOMES SOARES CANTAL, Porto Alegre (BR); Scott Alan WHITE, Boise, ID (US); Andre Luiz LIMA PEDRO, Porto Alegre (BR); Jun Zeng, Palo Alto, CA (US)

(21) Appl. No.: 18/024,678

(22) PCT Filed: Sep. 4, 2020
(86) PCT No.: PCT/US2020/049553

§ 371 Date: Mar. 3, 2023

(51) Int. Cl. G06Q 10/04; G06N 3/126

(52) U.S. Cl. CPC G06Q 10/04; G06N 3/126

(57) ABSTRACT

Examples of methods for determining object packings are described herein. In some examples, a method includes determining, for each of a plurality of objects, an initial orientation corresponding to a minimum bounding box. In some examples, the method includes determining a packing of the plurality of objects using the initial orientations with a genetic procedure.

### BACKGROUND

Three-dimensional (3D) solid objects may be produced from a digital model using additive manufacturing. Additive manufacturing may be used in rapid prototyping, mold generation, mold master generation, and short-run manufacturing. Additive manufacturing involves the application of successive layers of build material. This is unlike some machining processes that often remove material to create the final object. In some additive manufacturing techniques, the build material may be cured or fused.

### BRIEF DESCRIPTION OF THE DRAWINGS

FIG. 1 is a flow diagram illustrating an example of a method for determining a packing;

FIG. 2 is a block diagram of an example of an apparatus that may be used in packing selection;

FIG. 3 is a block diagram illustrating an example of a computer-readable medium for chromosome selection;

FIG. 4 is a diagram illustrating an example of a bounding box and an example of a minimum bounding box; and

FIG. 5 is a diagram illustrating examples of packings.

### DETAILED DESCRIPTION

Additive manufacturing may be used to manufacture three-dimensional (3D) objects. 3D printing is an example of additive manufacturing. Performing additive manufacturing may rely on a packing. A packing is information that specifies an arrangement (e.g., position, location, orientation, etc.) of objects in a build volume. A build volume is a 3D space. A build volume may correspond to a physical space in which additive manufacturing may be performed. It may be helpful to increase packing density in the build volume to increase production and/or reduce manufacturing costs.

In some examples, object packing may be based on an objective or objectives. An example of an objective is packing density (e.g., increasing or maximizing packing density). Object packing questions may be computationally intensive to solve, being nondeterministic polynomial- (NP-) complete. For example, computational complexity may grow exponentially in NP-complete questions. For instance, the size of the solution space (e.g., number of possible packing arrangements) for placement of objects (without rotation, for example) in a relatively small batch of 20 objects, is beyond the order of 1×10¹⁸. Some examples of the techniques described herein may provide practical and/or near-optimal approaches for object packing. For instance, some of the techniques described herein may enable searching over the solution space while prioritizing portions that have a greater probability of producing a near-optimal solution. In some examples, a relatively small portion of the solution space may be searched.

Throughout the drawings, identical or similar reference numbers may designate similar, but not necessarily identical, elements. When an element is referred to without a reference number, this may refer to the element generally, without necessary limitation to any particular Figure. The figures are not necessarily to scale, and the size of some parts may be exaggerated to more clearly illustrate the example shown. Moreover, the drawings provide examples in accordance with the description; however, the description is not limited to the examples provided in the drawings.

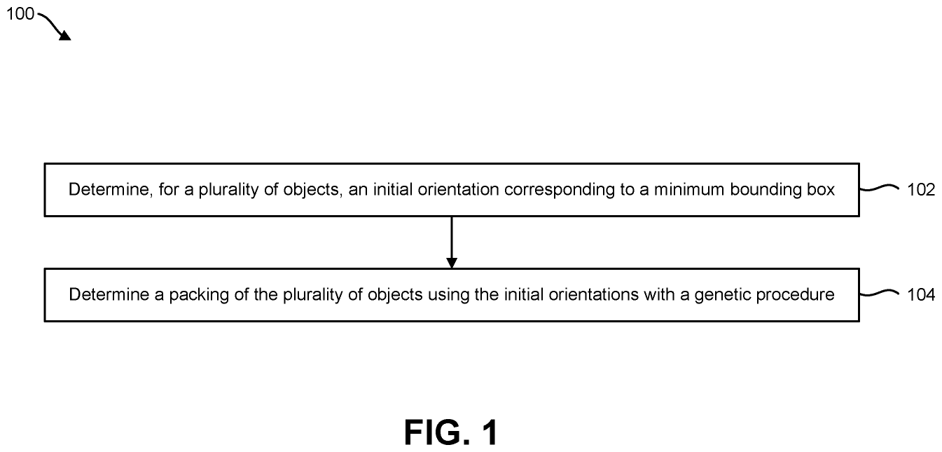

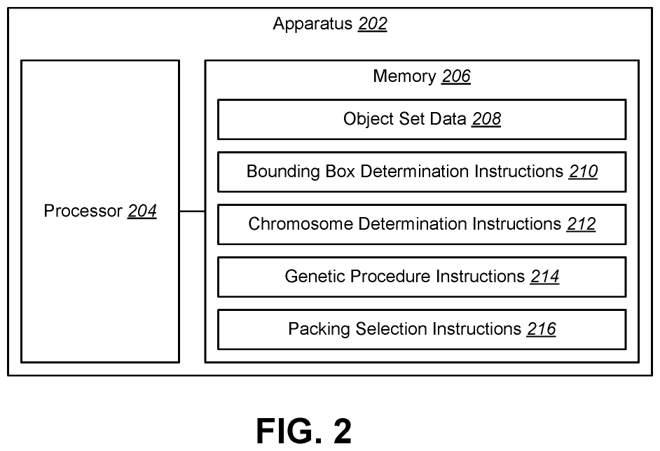

FIG. 1 is a flow diagram illustrating an example of a method 100 for determining a packing. The method 100 and/or a method 100 element or elements may be performed by an apparatus (e.g., electronic device). For example, the method 100 may be performed by the apparatus 202 described in relation to FIG. 2.

A genetic procedure is a computational procedure. For example, a genetic procedure may be a metaheuristic procedure that includes evolution and/or selection mechanisms for determining a solution. In some examples, a genetic procedure may be a technique utilized in artificial intelligence. In some examples, the genetic procedure may include initializing a population, evaluation, selection, crossover, and/or mutation operations. In some examples, evaluation, selection, crossover, and/or mutation may be performed repeatedly (e.g., iteratively, recursively, etc.) until an end condition is met. In some examples of the techniques described herein, a genetic procedure may be utilized to determine a packing.

The apparatus may determine 102, for each of a plurality of objects, an initial orientation corresponding to a minimum bounding box. In some examples, determining 102 the initial orientations may be performed to initialize a population. An initial orientation is a starting orientation for determining a packing. In some examples, the apparatus may determine an initial orientation for each of the plurality of objects by determining a minimum bounding box for each of the plurality of objects. The orientation of an object in the minimum bounding box may be the initial orientation for the object.

A bounding box is a cuboid that includes an object or objects (e.g., object model(s)). For example, a bounding box is a geometrical box shape that contains an object within the dimensions of the bounding box. A volume of a bounding box may depend on an orientation of the object within the bounding box. For instance, different orientations of an object may result in bounding boxes with different volumes. A minimum bounding box is a bounding box with a smallest volume that contains an object. In some examples, the apparatus may determine a minimum bounding box for each object of a set of objects. For instance, the apparatus may compute a convex hull procedure in order to determine a minimum bounding box for each object. The minimum bounding box for an object may correspond to an orientation of the object. For instance, the object may be oriented at an orientation (e.g., rotation(s) around x, y, and/or z axes) to permit the bounding box to have a minimum volume.

In some examples, determining 102 the initial orientations may be utilized to determine a chromosome or chromosomes. A chromosome is data. For example, a chromosome may include data representing a potential solution for a question that the genetic procedure is to address. For instance, chromosomes may indicate packing positions. A packing position is a pose of an object in a build volume. A packing may include multiple packing positions corresponding to a plurality of objects. For instance, a chromosome may correspond to and/or may represent a packing. In some examples, a chromosome may include data indicating a set of object identifiers and poses. An object identifier is information (e.g., number, floating point number, integer, string, character(s), name, etc.) that identifies an object. A pose is information indicating a location and/or orientation of an object. For instance, a pose may indicate a location (e.g., translation) of an object in a build volume and/or an orientation (e.g., rotation(s) in a dimension or dimensions) of an object in a build volume. In some examples, a pose may be expressed as a number or numbers (e.g., floating point numbers, integers, etc.), vector(s), matrix or matrices, quaternion(s), etc. In some examples, a chromosome may include an object identifier with a first axis rotation (e.g., x), a second axis rotation (e.g., y), and a third axis rotation (e.g., z) for each of a set of objects (e.g., the plurality of objects).

In some examples, a chromosome may include data for each object in an order or sequence. In some examples, the order or sequence may establish a priority queue. For instance, the order or sequence may indicate an order that objects may be introduced into a build volume. In some examples, the order or sequence may identify a chromosome. For instance, the order or sequence may remain the same through some changes to the chromosome (e.g., in some types of mutations). In some examples, a chromosome may include an object identifier and rotations for respective objects from object 1 to object n. In some examples, the order or sequence of a chromosome may be an order or sequence of object identifiers. For instance, the order or sequence of object identifiers of a chromosome may identify the chromosome. A chromosome identifier is a value (e.g., number, vector, list, set of numbers, ordered quantities, concatenated object identifiers, etc.) that identifies a chromosome. For example, a chromosome identifier may be the order or sequence (e.g., order or sequence of object identifiers). In some examples, a set of chromosomes may represent a set of potential packings described as a sequence of object identifiers with associated poses.

A population is a group or set of chromosomes. Some approaches to initialize a population may treat initial object location and/or pose arbitrarily. For instance, some approaches may determine random initial object locations and/or poses. Potential object rotations for packing may be bounded by the size of the build volume. A larger number of potential rotations may imply a larger solution space. Poor initial orientation for an object or object may reduce a likelihood of determining a good packing using a genetic procedure. Some examples of the techniques described herein may include a heuristic for initializing object orientations.

In some examples, the method 100 may include determining a chromosome or chromosomes based on the initial orientations corresponding to the minimum bounding boxes. For instance, the apparatus may utilize the initial orientations as poses for the chromosome or chromosomes in the initial population. In some examples, a chromosome may include a set of object identifiers with the initial orientations for the plurality of objects.

In some examples, the apparatus may determine additional initial orientations based on the initial orientations. For example, the apparatus may determine a chromosome or chromosomes of the initial population using a constrained randomizing operation or operations. For instance, the apparatus may randomize the order or sequence of the objects to produce chromosomes in the initial population. In some examples, the apparatus may apply a rotation or rotations to an initial orientation that preserves the minimum bounding box volume to produce chromosomes in the initial population (e.g., to produce additional initial orientations). For instance, the apparatus may apply a rotation or rotations selected randomly from a constrained set of rotations to produce chromosomes in the initial population. For instance, the constrained set of rotations may include rotations that are multiples of 90 degrees (e.g., 0, 90, 180, 270) for each axis. Rotations that are multiples of 90 degrees may preserve the minimum bounding box volume. Accordingly, the apparatus may determine an initial population of chromosomes by utilizing the constrained randomizing operations to vary orders and/or orientations of chromosomes.

The apparatus may determine 104 a packing of the plurality of objects using the initial orientations with a genetic procedure. For example, the apparatus may perform an operation or operations of the genetic procedure based on the initial orientations (e.g., the initial chromosome population that is based on the initial orientations). For instance, the apparatus may execute the genetic procedure (e.g., evaluation, selection, crossover, and/or mutation) based on the chromosome or chromosomes (e.g., the initial chromosome population that is determined based on the initial orientations).

In performing evaluation, the apparatus may evaluate and/or rank the chromosomes according to a fitness measure. A fitness measure is a measure that indicates a degree to which a chromosome (e.g., packing) satisfies an objective or objectives (e.g., increased packing density, increased number of objects packed, decreased packing height and/or z-axis measure, etc.). For example, the fitness measure may be evaluated for each chromosome (e.g., packing). Examples of fitness measures may include packing density, number of objects packed, and/or packing height (e.g., z-height). In some examples, the fitness measure may be utilized to rank or order chromosomes. In some examples, a group of fitness measures or parameters may be assembled to form a packing score that can be utilized to rank one packing over another packing. In some examples, chromosomes with relatively greater packing density, a relatively greater number of objects packed, and/or a relatively lesser packing height may be ranked higher than other chromosomes.

In performing selection, the apparatus may eliminate a portion of the chromosomes. For instance, the apparatus may eliminate (e.g., discard, delete, remove, exclude, etc.) a portion of the lowest ranked chromosomes (e.g., a percentage of lowest ranked chromosomes, a quantity of lowest ranked chromosomes, etc.). In some examples, the chromosomes may be categorized based on rank. For example, a first portion (e.g., percentage of chromosomes, number of chromosomes, etc.) of the chromosomes may be categorized in a first category. For instance, the first portion may be a set of highest ranked chromosomes. The first portion of chromosomes may be referred to as elite chromosomes (e.g., a portion of chromosomes with best fitness measures). In some examples, a gene or genes (e.g., object identifier(s) and/or pose(s)) of the elite chromosomes may be preserved and/or propagated to a subsequent (e.g., next) generation of chromosomes. A generation is a set of chromosomes (e.g., packings). For example, a generation may correspond to each iteration of the genetic procedure.

In performing crossover, the apparatus may utilize a second portion of chromosomes and elite chromosomes. The second portion of the chromosomes may be referred to as crossover chromosomes. The second portion of chromosomes may be ranked below the elite chromosomes. For instance, the apparatus may randomly select chromosomes that are ranked below the elite chromosomes to select the crossover chromosomes. The apparatus may crossover the crossover chromosomes with the elite chromosomes. For example, the apparatus may combine a portion or portions (e.g., gene(s), object identifier(s), pose(s), location(s), rotation(s), and/or sequence position(s)) of an elite chromosome with a portion or portions (e.g., gene(s), object identifier(s), pose(s), location(s), rotation(s), and/or sequence position(s)) of a crossover chromosome to generate a child chromosome in a subsequent (e.g., next) generation of chromosomes.

In performing mutation, the apparatus may randomly mutate an elite chromosome or elite chromosomes. For example, the apparatus may randomly change a gene or genes (e.g., object identifier(s), pose(s), location(s), rotation(s), orientation(s), and/or sequence position(s)) of an elite chromosome or elite chromosomes. The chromosomes to be mutated may be referred to as mutation chromosomes.

In some examples, a constant population size (e.g., number of chromosomes) may be maintained over generations. In some examples, the population size may vary over generations. In some examples, new random chromosomes may be added. For instance, a set of randomly generated chromosomes may be added to the elite chromosomes, crossover chromosomes, and mutation chromosomes. For instance, adding new random chromosomes may maintain the constant population size. The random chromosomes may be useful for driving a random search in different directions in the solution space. In some approaches, mutations of chromosomes may be represented as random movements in the object sequence and/or random rotations on the object orientations. The mutation stage may be utilized to mutate elite chromosomes (e.g., good solutions) into chromosomes with increased fitness (e.g., better solutions). Performing selection, crossover, and/or mutation may produce a subsequent generation of chromosomes.

In some examples, the method 100 may include performing a mutation in the genetic procedure based on an initial orientation of the initial orientations. For instance, the apparatus may apply a mutation to an orientation of an object that is based on an initial orientation corresponding to a minimum bounding box. In some examples, performing the mutation may include performing a rotation of an initial orientation. For instance, the apparatus may apply a rotation (e.g., random rotation) to an orientation of an object in a chromosome that is based on an initial orientation. In some examples, the rotation may maintain a minimum bounding box volume of the initial orientation. For instance, the rotation may rotate the orientation of an object in a chromosome such that the volume of a bounding box of the object after rotation is the same as the volume of the minimum bounding box before rotation. In some examples, the rotation may be a multiple of 90 degrees on an axis or axes (e.g., x, y, and/or z).

In some examples, determining 104 the packing may include selecting a packing corresponding to a chromosome. For instance, the method 100 may include selecting a packing based on the chromosomes (e.g., chromosomes after a generation or generations). In some examples, selecting the packing is based on the genetic procedure with an objective to increase packing density and/or to reduce packing height. For instance, the apparatus may select a chromosome that represents a packing with a highest ranking and/or best fitness measure. In some examples, the apparatus may select the packing based on an objective (e.g., packing density, packing height, etc.) or a combination of objectives. For instance, a packing with a best combination of objectives, such as packing density and packing height, may be selected.

In some examples, the packing may be executed to manufacture the objects. For example, the objects may be manufactured by an apparatus (e.g., 3D printer) in accordance with the determined 104 packing. For instance, an apparatus may send the packing to another device (e.g., 3D printer) or may execute the packing to manufacture the objects in the packing. It should be noted that some examples of the techniques described herein may be utilized in a variety of additive manufacturing. Some additive manufacturing techniques may be powder-based and driven by powder fusion. Some additive manufacturing techniques may include metal printing, such as metal jet fusion. Some examples of the approaches described herein may be utilized in powder bed fusion-based additive manufacturing, such as Selective Laser Melting (SLM), Selective Laser Sintering (SLS), Multi-Jet Fusion (MJF), etc.

FIG. 2 is a block diagram of an example of an apparatus 202 that may be used in packing selection. The apparatus 202 may be an electronic device, such as a personal computer, a server computer, a printer, a 3D printer, a smartphone, a tablet computer, etc. The apparatus 202 may include and/or may be coupled to a processor 204 and/or a memory 206. In some examples, the apparatus 202 may be in communication with (e.g., coupled to, have a communication link with) an additive manufacturing device (e.g., a 3D printing device). In some examples, the apparatus 202 may be an example of a 3D printing device. The apparatus 202 may include additional components (not shown) and/or some of the components described herein may be removed and/or modified without departing from the scope of the techniques described herein.

The processor 204 may be any of a central processing unit (CPU), a semiconductor-based microprocessor, graphics processing unit (GPU), field-programmable gate array (FPGA), an application-specific integrated circuit (ASIC), and/or other hardware device suitable for retrieval and execution of instructions stored in the memory 206. The processor 204 may fetch, decode, and/or execute instructions (e.g., chromosome determination instructions 212, bounding box determination instructions 210, genetic procedure instructions 214, and/or packing selection instructions 216) stored in the memory 206. In some examples, the processor 204 may include an electronic circuit or circuits that include electronic components for performing a function or functions of the instructions (e.g., chromosome determination instructions 212, bounding box determination instructions 210, genetic procedure instructions 214, and/or packing selection instructions 216). In some examples, the processor 204 may perform one, some, or all of the functions, operations, elements, methods, etc., described in relation to one, some, or all of FIGS. 1-5.

The memory 206 may be any electronic, magnetic, optical, or other physical storage device that contains or stores electronic information (e.g., executable instructions, executable code, and/or data). The memory 206 may be, for example, Random Access Memory (RAM), Electrically Erasable Programmable Read-Only Memory (EEPROM), a storage device, an optical disc, and the like. In some examples, the memory 206 may be volatile and/or non-volatile memory, such as Dynamic Random Access Memory (DRAM), EEPROM, magnetoresistive random-access memory (MRAM), phase change RAM (PCRAM), memristor, flash memory, and the like. In some examples, the memory 206 may be a non-transitory tangible machine-readable storage medium, where the term “non-transitory” does not encompass transitory propagating signals. In some examples, the memory 206 may include multiple devices (e.g., a RAM card and a solid-state drive (SSD)).

In some examples, the apparatus 202 may include an input/output interface (not shown in FIG. 2) through which the processor 204 may communicate with an external device or devices (not shown), for instance, to receive and store information (e.g., object set data 208) pertaining to an object or objects to be manufactured (e.g., printed). The input/output interface may include hardware and/or machine-readable instructions to enable the processor 204 to communicate with the external device or devices. The input/output interface may enable a wired or wireless connection to the external device or devices. The input/output interface may further include a network interface card and/or may also include hardware and/or machine-readable instructions to enable the processor 204 to communicate with various input and/or output devices, such as a keyboard, a mouse, a display, another apparatus, electronic device, computing device, etc., through which a user may input instructions into the apparatus 202.

In some examples, the memory 206 may store object set data 208. The object set data 208 may be obtained (e.g., received) from an external device and/or may be generated on the apparatus 202. For example, the processor 204 may execute instructions (not shown in FIG. 2) to receive the object set data 208 from an external device and/or to generate models of objects on the apparatus 202.

The object set data 208 may include data indicating objects and/or shapes (e.g., 3D models, dimensions, etc.) of objects. For example, the objects set data 208 may indicate a set of objects for packing and/or manufacture.

In some examples, the processor 204 may execute bounding box determination instructions 210 to determine a set of minimum bounding boxes corresponding to a set of objects. In some examples, determining the set of minimum bounding boxes may be performed as described in relation to FIG. 1. For instance, the processor 204 may determine minimum bounding boxes of the objects and corresponding orientations of the objects in the minimum bounding boxes.

In some examples, the processor 204 may execute the chromosome determination instructions 212 to determine a chromosome or chromosomes based on the set of minimum bounding boxes corresponding to the set of objects. In some examples, determining the chromosome(s) based on the set of minimum bounding boxes may be performed as described in relation to FIG. 1. For instance, the processor 204 may determine a chromosome that includes orientations of objects in the minimum bounding boxes. In some examples, the processor 204 may determine multiple chromosomes based on the orientations to produce an initial population of chromosomes.

In some examples, the processor 204 may execute the genetic procedure instructions 214 to execute a genetic procedure based on the chromosome(s). In some examples, executing the genetic procedure may be performed as described in relation to FIG. 1. For example, the processor 204 may perform evaluation, selection, crossover, and/or mutation based on the chromosome(s). For instance, processor may rotate a pose of an object of the chromosome in the genetic procedure (e.g., in mutation).

In some examples, the processor 204 may execute the packing selection instructions 216 to select a packing of the set of objects based on the genetic procedure. In some examples, selecting the packing may be performed as described in relation to FIG. 1. For example, the processor 204 may select the packing as a chromosome with a best fitness measure from a set of chromosomes. For instance, the processor 204 may select the packing as a packing with a greatest packing density and/or least packing height from a set of chromosomes produced by the genetic procedure.

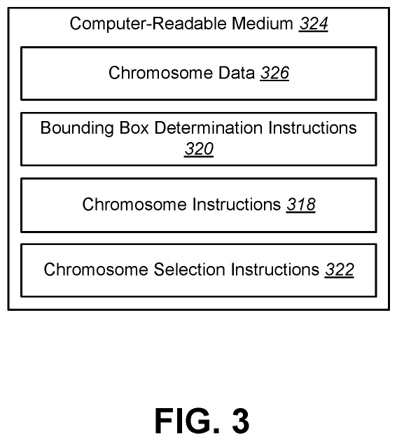

FIG. 3 is a block diagram illustrating an example of a computer-readable medium 324 for chromosome selection. The computer-readable medium is a non-transitory, tangible computer-readable medium 324. The computer-readable medium 324 may be, for example, RAM, EEPROM, a storage device, an optical disc, and the like. In some examples, the computer-readable medium 324 may be volatile and/or non-volatile memory, such as DRAM, EEPROM, MRAM, PCRAM, memristor, flash memory, and the like. In some examples, the memory 206 described in relation to FIG. 2 may be an example of the computer-readable medium 324 described in relation to FIG. 3.

The computer-readable medium 324 may include code (e.g., data and/or instructions). For example, the computer-readable medium 324 may include chromosome data 326, chromosome instructions 318, bounding box determination instructions 320, and/or chromosome selection instructions 322.

The chromosome data 326 may include information indicating a plurality of chromosomes (e.g., packings). For example, the chromosome data 326 may correspond to and/or indicate a set of packings, a group of packings, a population of packings, and/or generations of packings. For instance, operations may be performed as described herein to determine a plurality of chromosomes that represent packings. The chromosomes may be stored as chromosome data 326.

In some examples, the bounding box determination instructions 320 are code to cause a processor to determine minimum bounding boxes of a set of objects. For example, the processor may execute the bounding box determination instructions 320 to determine orientations corresponding to minimum bounding boxes of the set of objects. In some examples, determining the minimum bounding boxes may be accomplished as described in relation to FIG. 1 and/or FIG. 2.

In some examples, the chromosome instructions 318 are code to cause a processor to determine initial chromosomes based on orientations of the set of objects in the minimum bounding boxes. In some examples, determining initial chromosomes based on orientations of the set of objects in the minimum bounding boxes may be accomplished as described in relation to FIG. 1 and/or FIG. 2.

In some examples, the chromosome instructions 318 may include code to cause the processor to perform a genetic procedure based on the initial chromosomes to produce a subsequent generation of chromosomes. For instance, the chromosome instructions 318 may include code to cause the processor to perform evaluation, selection, crossover, and/or mutation (iteratively and/or recursively, for example) to produce a subsequent generation of chromosomes. In some examples, performing the genetic procedure based on the initial chromosomes may be performed as described in relation to FIG. 1 and/or FIG. 2.

In some examples, the chromosome selection instructions 322 are code to cause the processor to select a chromosome from the subsequent generation of chromosomes to determine a packing. For example, the chromosome selection instructions 322 may include code to cause the processor to select the chromosome based on an associated fitness measure. Examples of fitness measure include packing height and/or packing density. For instance, the chromosome selection instructions 322 may cause a processor to determine a best packing in terms of packing efficiency and/or packing height from chromosomes that are a generation or generations after the initial generation. In some examples, selecting the chromosome to determine the packing may be performed as described in relation to FIG. 1 and/or FIG. 2.

To determine a packing in some examples, packing scores may be compared. A packing score is a score indicating a fitness measure or a combination of fitness measures. An example of packing selection is given as follows. Assume two packings A and B with corresponding packing scores s_A and s_B. In some examples, a packing score s_X may include parameters (e.g., k parameters or fitness measures): s_X={p1_X, p2_X, . . . , pk_X}, where px_X is a parameter or fitness measure. A quantity (e.g., k) of threshold values may be utilized: α, β, . . . , φ. If the first k−1 parameters of each packing are relatively closer to each other (up to an adjustable threshold), a Boolean value of (p1_A>p1_B) may indicate whether s_A is greater than s_B. For instance, In a case that abs(p1_A−p1_B)<α and abs(p2_A−p2_B)<β and so on for the rest of the parameters, and (pk_A !=pk_B), then a Boolean value of (pk_A>pk_B) may indicate whether s_A is greater than s_B. Otherwise, a parameter number k−1 may be compared. For instance, in a case that abs(p1_A−p1_B)<α and abs(p2_A−p2_B)<β and so on for the rest of the parameters, and (pk−1_A !=pk−1_B), then a Boolean value of (pk−1_A>pk−1_B) may indicate whether s_A is greater than s_B. Otherwise, similar comparisons may be made for a parameter or parameters (e.g., pk−2_A !=pk−2_B and so on) until the final case, where (p1_A>p1_B) may indicate whether s_A is greater than s_B. The packing with the greatest score may be selected. It should be noted that one parameter or multiple parameters may be utilized in the comparison.

In some examples, the computer-readable medium 324 may include code for causing a processor to manufacture the selected packing. For example, the code may cause a processor to execute instructions and/or send instructions to another device (e.g., 3D printer) to manufacture the selected packing.

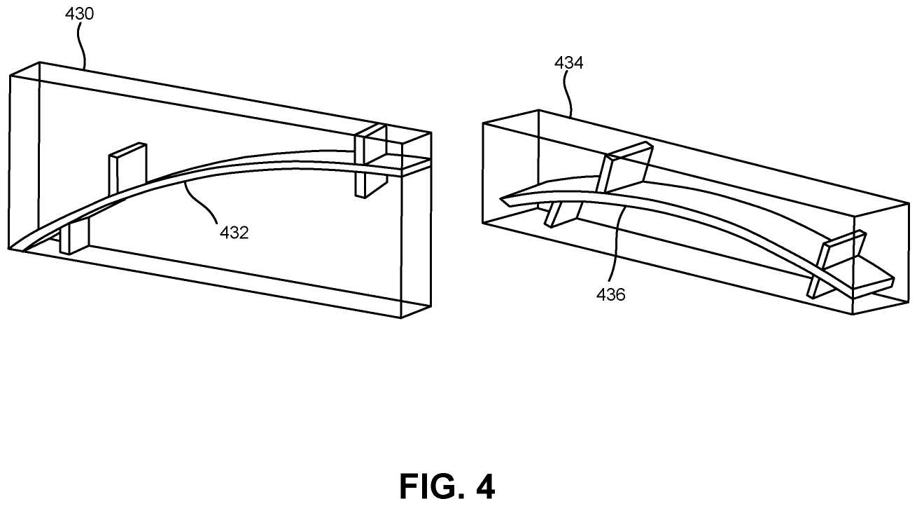

FIG. 4 is a diagram illustrating an example of a bounding box 430 and an example of a minimum bounding box 434. Initialization of object orientation is one aspect of that may impact a packing density determined using a genetic procedure. In some approaches, initial object orientations are arbitrary. In some examples, a bounding box of an object may be determined as a smallest cuboid that is aligned to a canonical axis and that contains the whole object. In FIG. 4, the bounding box 430 is aligned to a canonical axis. An object 432 is oriented at a first orientation within the bounding box 430. As described above, bounding box volume depends on the orientation of the object. In FIG. 4, the object 436 at a second orientation may fit within a minimum bounding box 434. In some examples, a minimum bounding box may have a smallest volume that contains an object and/or may not necessarily be aligned to the canonical axis. For example, a minimum bounding box may be misaligned relative to a canonical axis in some cases. In some examples of the techniques described herein, orientations of objects corresponding to minimum bounding box may be determined and used as initial orientations for a genetic procedure.

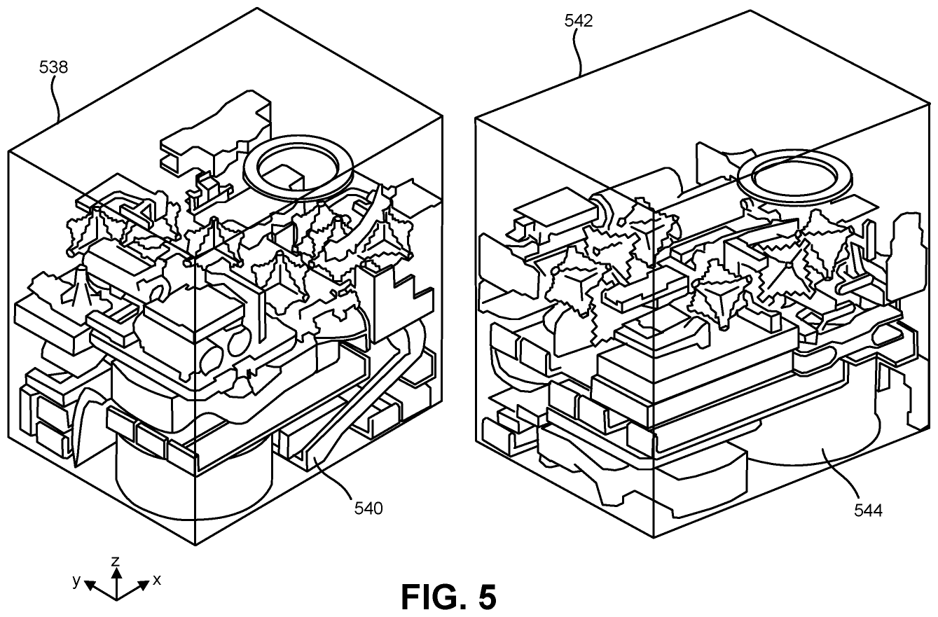

FIG. 5 is a diagram illustrating examples of packings 540, 544. The examples of packings 540 each include 69 objects. A first packing 540 was determined using arbitrary initial orientations and has a packing height of 270 millimeters (mm) in a first build volume 538. A second packing 544 as determined using orientations based on minimum bounding boxes and has a packing height of 260 mm in a second build volume 542. In some examples, using orientations from minimum bounding boxes to initialize orientations may result in better packings (with greater packing density and/or less packing height) and/or may take less time to compute than packings from arbitrary orientations.

In some examples of the techniques described herein, volume-preserving rotations may be applied during chromosome mutation. For instance, a volume-preserving rotation may be a rotation from a set of four potential rotations (e.g., 0, 90, 180, 270), since 90-degree rotations on any axis may preserve minimum bounding box volume. Accordingly, arbitrary mutations may not be utilized in some cases, since arbitrary mutations are less likely to result in a minimum bounding box volume. As illustrated in FIG. 5, utilizing minimum bounding boxes for initial object orientations may provide better packing density results versus arbitrary initial orientations.

As used herein, the term “and/or” may mean an item or items. For example, the phrase “A, B, and/or C” may mean any of: A (without B and C), B (without A and C), C (without A and B), A and B (but not C), B and C (but not A), A and C (but not B), or all of A, B, and C.

While various examples are described herein, the disclosure is not limited to the examples. Variations of the examples described herein may be within the scope of the disclosure. For example, aspects or elements of the examples described herein may be omitted or combined.

1. A method, comprising:
determining, for each of a plurality of objects, an initial orientation corresponding to a minimum bounding box; and
determining a packing of the plurality of objects using the initial orientations with a genetic procedure.

2. The method of claim 1, further comprising determining a chromosome based on the initial orientations corresponding to the minimum bounding boxes.

3. The method of claim 2, further comprising executing the genetic procedure based on the chromosome.

4. The method of claim 2, wherein the chromosome comprises a set of object identifiers with the initial orientations for the plurality of objects.

5. The method of claim 1, wherein the minimum bounding box is misaligned relative to a canonical axis.

6. The method of claim 1, further comprising performing a mutation in the genetic procedure based on a first initial orientation of the initial orientations.

7. The method of claim 6, wherein performing the mutation comprises performing a rotation of the first initial orientation.

8. The method of claim 1, wherein the rotation maintains a minimum bounding box volume from the first initial orientation.

9. The method of claim 8, wherein the rotation comprises a multiple of 90 degrees on an axis or axes.

10. An apparatus, comprising:
a memory;
a processor coupled to the memory, wherein the processor is to:
determine a chromosome based on a set of minimum bounding boxes corresponding to a set of objects;
execute a genetic procedure based on the chromosome; and
select a packing of the set of objects based on the genetic procedure.

11. The apparatus of claim 10, wherein the processor is to rotate a pose of an object of the chromosome in the genetic procedure.

12. The apparatus of claim 10, wherein the processor is to determine the set of minimum bounding boxes corresponding to the set of objects.

13. A non-transitory tangible computer-readable medium storing executable code, comprising:
code to cause a processor to determine minimum bounding boxes of a set of objects;
code to cause the processor to determine initial chromosomes based on orientations of the set of objects in the minimum bounding boxes;
code to cause the processor to perform a genetic procedure based on the initial chromosomes to produce a subsequent generation of chromosomes; and
code to cause the processor to select a chromosome from the subsequent generation of chromosomes to determine a packing.

14. The computer-readable medium of claim 13, wherein the code to cause the processor to select the chromosome comprises code to cause the processor to select the chromosome based on an associated fitness measure.

15. The computer-readable medium of claim 13, wherein the fitness measure comprises a packing height.
